(19) United States
(12) Patent Application Publication
(10) Pub. No.: US 2008/0159117 A1
(43) Pub. Date: Jul. 3, 2008

(54) OPTICAL DISC, OPTICAL DISC REPRODUCING APPARATUS AND OPTICAL DISC REPRODUCING METHOD

(75) Inventors: Ryosuke YAMAMOTO, Yokohama-shi (JP); Masaaki MATSUMARU, Funabashi-shi (JP); Naomasa MAKAMURA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/953,430

(22) Filed: Dec. 10, 2007

(30) Foreign Application Priority Data
Dec. 27, 2006 (JP) 2006-352208

(51) Int. Cl. G11B 7/24

(52) U.S. Cl. 369/275.4

(57) ABSTRACT

According to one embodiment, an optical disc is an optical disc having a plurality of recording pits on a recording surface, each of the plurality of recording pits having a circumferential direction length corresponding to record data, and radial direction cross-sections of the recording pits of signals of 2T, 3T and 4T in the circumferential direction length having groove forms which have deepest points in the radial direction cross-sections and become shallower from the deepest points in correspondence with a difference amount in radial directions.

### CROSS-REFERENCE TO RELATED APPLICATIONS

This application is based upon and claims the benefit of priority from Japanese Patent Application No. 2006-352208, filed Dec. 27, 2006, the entire contents of which are incorporated herein by reference.

### BACKGROUND

1. Field

One embodiment of the invention relates to an optical disc on which an information pit is formed, an optical disc reproducing apparatus reproducing information recorded in the optical disc and an optical disc reproducing method.

2. Description of the Related Art

A conventional document (Patent Document 1: Japanese Patent Application Publication (KOKAI) No. 2004-206874) suggests a reproduction-only medium in which a sufficient reproduced signal margin is secured in a result of a simulation approximating a pit form having a soccer-stadium shape. However, a pit form providing a good reproduced signal is not limited to a form approximating the soccer-stadium shape. Pit forms created in an actual manufacturing line includes not only the soccer-stadium shape but also various shapes such as a shape close to a triangular pyramid and a round-bottom shape. Besides, there is a possibility that a good reproduced signal characteristic is obtained not with pit forms of the same type but with pit forms of different types.

The pit form of the reproduction-only medium depends on a creating process (mastering process) of a disc master. For example, in a method in which an exposed part is etched with a developing solution after a photoresist is exposed, a pit form becomes close to a soccer-stadium shape if development is carried out as far as to a substrate surface. Further, in order for a practical use in an actual production process, it is desirable that a pit form can be created in a highly manufacturable process (for example, in which creation time is short, a distribution of forms of created pits is uniform, and so on). However, in the above-described conventional document, only the pit capable of approximating the soccer-stadium shape is discussed, and actual manufacturability is not taken into consideration.

Besides, only a signal processing according to a mark edge method, which is employed in a DVD (Digital Versatile Disc), is assumed in the above-described conventional document. On the other hand, there is recently introduced in an HD DVD (High Definition DVD) and the like a medium enabling higher density by using a PRML (Partial Response and Maximum Likelihood) signal processing compared with the mark edge method. In another conventional document (Japanese Patent Application Publication (KOKAI) No. 2004-127468), there is suggested a board in which a shortest pit length is made conical and a pit depth is made shallow to realize high density, in a reproduction-only board using the PRML signal processing. In this case, the board is a single-side 15 GB medium (HD DVD-ROM (HD DVD Read Only Memory) of 0.204 μm, created to have a track pitch of 0.4 μm and a linear density of 0.153 μm/bit.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1(a) and FIG. 1(b) are exemplary first schematic views of a form of a recording pit in an optical disc according to the an embodiment of the invention;

FIG. 2(a) and FIG. 2(b) are exemplary second schematic views of a form of a recording pit in an optical disc in the embodiment;

FIG. 3 is an exemplary graph showing a simulation result of an exposure intensity profile;

FIG. 4 is an exemplary graph showing a simulation result (2T signal pit) of a cross-sectional profile in a disc radial direction in the embodiment;

FIG. 5 is an exemplary graph showing a simulation result (3T signal pit) of a cross-sectional profile in a disc radial direction in the embodiment;

FIG. 6 is an exemplary graph showing a simulation result (4T signal pit) of a cross-sectional profile in a disc radial direction in the embodiment;

FIG. 7(a) and FIG. 7(b) are exemplary schematic views of cross-sectional profiles in disc radial directions in the embodiment;

FIG. 8 is an exemplary graph showing a distribution of pit depths in relation to pit lengths in the embodiment;

FIG. 9 is an exemplary graph plotting a pit length in relation to a linear density in the embodiment;

FIG. 10 is an exemplary block diagram showing a configuration of an optical disc apparatus in the embodiment;

FIG. 11 is an exemplary table showing a reproduced signal characteristic of an optical disc in the embodiment; and

FIG. 12 is an exemplary table showing a length of a recording pit formed in an optical disc in the embodiment.

### DETAILED DESCRIPTION

Various embodiments according to the invention will be described hereinafter with reference to the accompanying drawings. In general, according to one embodiment of the invention, an optical disc is an optical disc having a plurality of recording pits on a recording surface, each of the plurality of recording pits having a circumferential direction length corresponding to record data, and radial direction cross-sections of the recording pits of signals of 2T, 3T and 4T in the circumferential direction length having groove forms which have deepest points in the radial direction cross-sections and become shallower from the deepest points in correspondence with difference amounts in radial directions.

An optical disc is an optical disc having a plurality of recording pits on a recording surface, each of the plurality of recording pits having a circumferential direction length corresponding to record data, and a radial direction cross-section of the recording pit whose circumferential length Lₚ is represented by any one of formulas

Lₚ=1333.3ρ(±10%)

and

Lₚ=1960.8ρ(±10%)

and

Lₚ=2614.4ρ(±10%)

(ρ indicates a linear density) having a groove form which has a deepest point in the radial direction cross-section and becomes shallower from the deepest point in correspondence with a difference amount in a radial direction.

### Overview of Optical Disc According to Embodiment

Overview of an optical disc of the embodiment will be described. The optical disc of the embodiment is a ROM (Read Only Memory) disc for reproduction-only on a recording surface of which numerous recording pits are formed in order to record various data such as video data and sound data. On the recording surface of the optical disc, there are tracks in a given interval in a radial direction, and groove-formed recording pits are formed along respective tracks. Here, a pit depth and a pit length (length in a circumferential direction) of each recording pit correspond to record data (“1” or “0”)

The optical disc of the embodiment has a following shape. That is, in the optical disc of the embodiment, a radial direction cross-section of the recording pit of signals of 2T, 3T and 4T (T: length corresponding to a cycle of a reference clock) in pit lengths have groove forms which have deepest points in approximate centers of pit widths being the radial direction lengths of the recording pits and which become shallower from the deepest points in correspondence with difference amounts in the radial directions. Hereby, the recording pits of the 2T, 3T and 4T signals have a form of a circular conical hole or a form of a V-groove.

The form of the above-described optical disc can also be described as follows. That is, in the optical disc of the embodiment, a radial direction cross-section of a recording pit whose pit length Lₚ is represented by any one of following formulas (1), (2) and (3) (“ρ” indicates a linear density) has a groove form which has a deepest point in an approximate center of a pit width and which becomes shallower from the deepest point in correspondence with a difference amount in the radial direction.

Lₚ=1333.3ρ(±10%) (1)

Lₚ=1960.8ρ(±10%) (2)

Lₚ=2614.4ρ(±10%) (3)

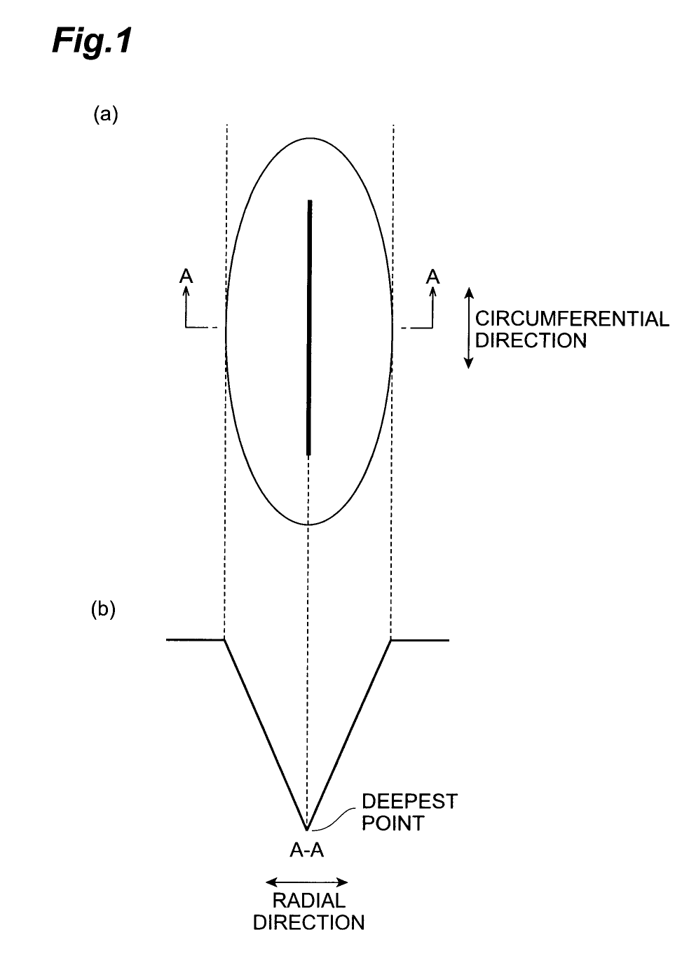

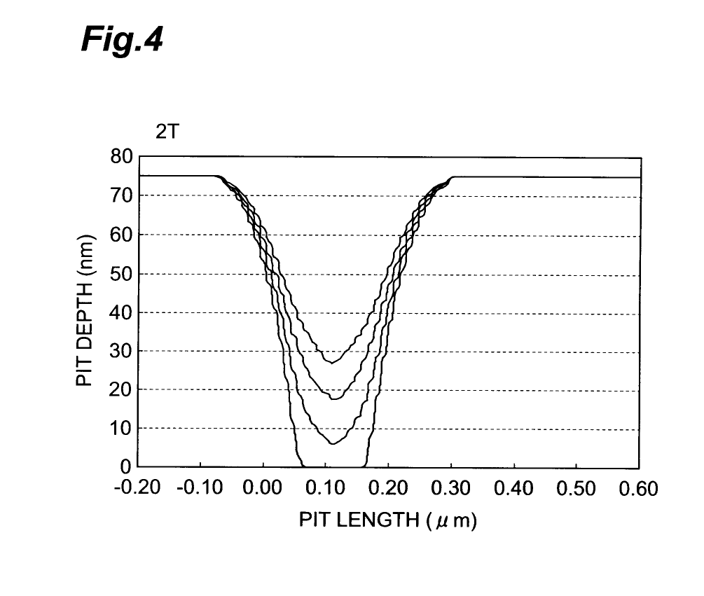

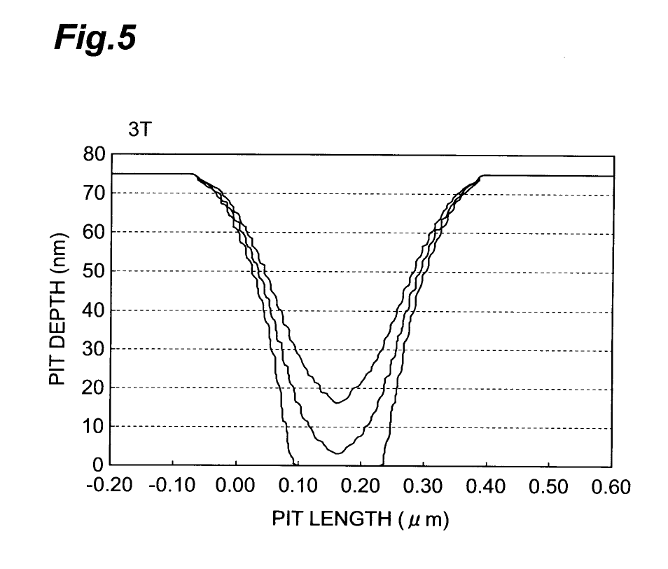

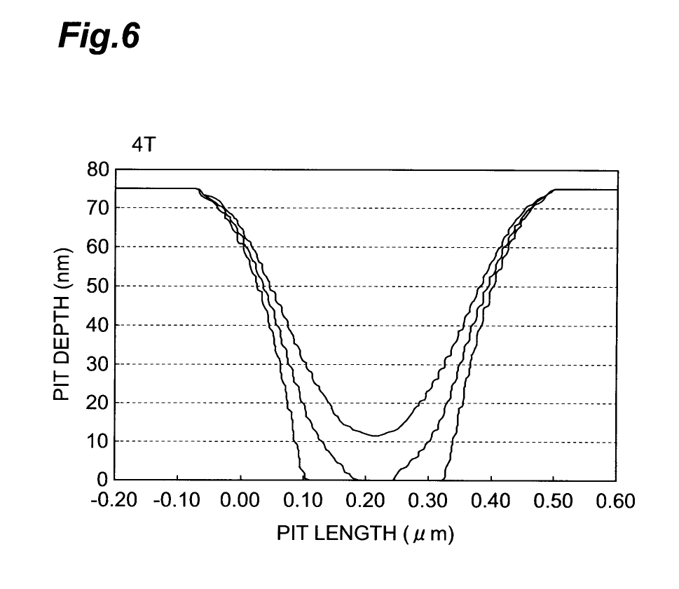

FIG. 1(a) and FIG. 1(b) are schematic views of the form of the recording pit described above. FIG. 1(a) is a front view of the recording pit formed on the recording surface of the optical disc, while FIG. 1(b) is an A-A cross-sectional view of the recording pit. Though the radial direction cross-section of the recording pit is V-formed in FIG. 1(b), the radial direction cross-section in reality has a rounder form (see FIG. 4, FIG. 5 and FIG. 6). In descriptions hereinafter, such form of the recording pit is referred to as almost V-form.

As a result of keen investigation by the inventor, it is found that making a recording pit almost V-formed leads to a reproduced signal satisfying a standard value and improves a data recording density in a disc circumferential direction compared to a conventional optical disc. In particular, when an optical disc has a high recording density, pit widths of recording pits of 2T, 3T and 4T signals become shorter than 60% of a diameter of a reproducing laser spot, and in such a circumstance it is preferable that a radial direction cross-section of the recording pit is almost V-formed.

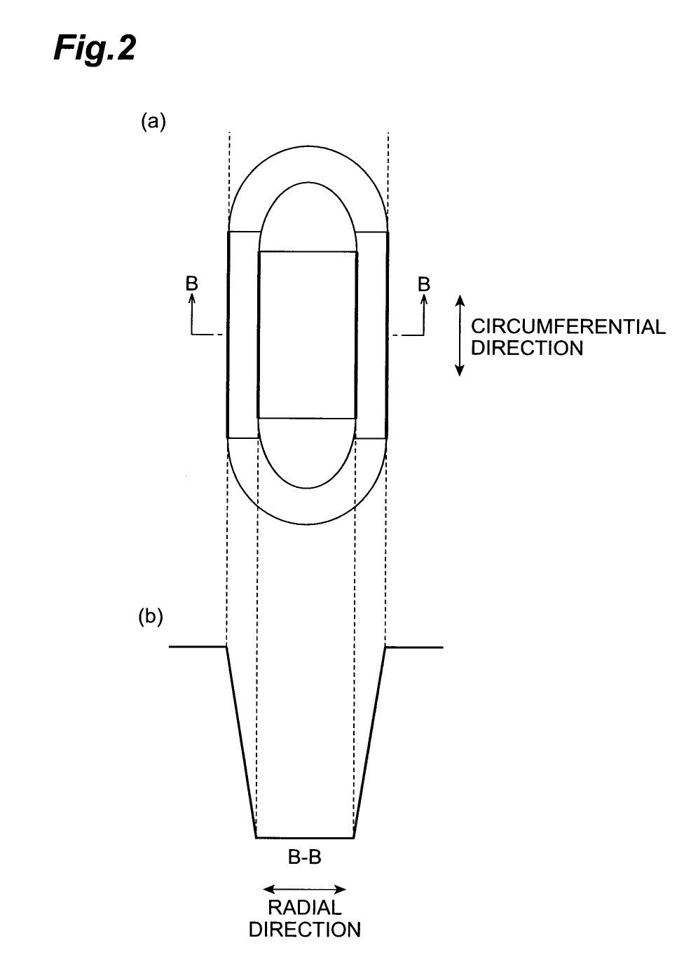

As stated above, while the recording pits of the 2T, 3T and 4T signals have the circular conical hole form or the V-groove form, a recording pit of 5T signal or more has a form of a soccer-stadium shape. FIG. 2(a) and FIG. 2(b) are schematic views of the forms of the succor-stadium shaped recording pit. FIG. 2(a) is a front view of a recording pit formed on a recording surface of an optical disc, while FIG. 2(b) is a B-B cross-sectional view of the recording pit. In the soccer-stadium shaped recording pit, a bottom of the recording pit is planate. In the embodiment, the recording pits of the 2T, 3T and 4T signals are made to have the circular conical hole form or the V-groove form while the recording pit of the 5T signal or more has the form of the soccer-stadium shape, whereby it is possible to make the optical disc suitable for large-scale production and to make the reproduced signal obtained from the optical disc suitable for a PRML method.

### Details of Optical Disc According to Embodiment

Details of the optical disc of the embodiment will be described hereinafter.

A manufacturing method of an optical disk master for manufacturing the optical disc of the embodiment will be described. A resist material being a photosensitive material is applied in a predetermined thickness on a glass board by using a spin coat method. The resist thin film is exposed by a master exposure recording apparatus so that a latent image of a pit or a groove is recorded, and then a development treatment is performed by using a developing solution such as an alkaline solution (for example, TMAH and the like). In a case of a positive resist, an exposed part is eluted off and in a case of a negative resist, an exposed part is left, whereby the pit or a groove pattern is created. The optical disc of the embodiment is manufactured by using the optical disc master manufactured as above.

In a reproduction-only optical disc such as the optical disk of the embodiment, a pit form created on the disc master influences a characteristic of a reproduced signal. Therefore, a mastering process of creating the above-described disc master almost determines the characteristic of the reproduced signal. Note that though the above-described manufacturing method of the optical disc master is basically the same as a manufacturing method of a conventional optical disk master such as a DVD and a CD, the method is different in that the exposure to the resist material in the master exposure recording apparatus is appropriately adjusted or in that the resist material is appropriately selected, as will be described below.

Conditions influencing the pit form to be created in the mastering process are mainly following two points, and for manufacturing the optical disc of the embodiment it is important to adjust these two points appropriately.

1. master exposure apparatus (exposure wavelength and recording light amount)

2. resist material characteristic (photosensitivity and resolution of formation pattern)

Incidentally, similar conditions are also important in a semiconductor lithography field, and this is a reason why a condensed intensity profile on a resist surface, a resist development speed analysis, a simulation calculation thereof and the like are actively pursued.

It is also necessary to consider a fact that a pit width of the recording pit formed on the optical disc of the embodiment is smaller than a condensed spot of a beam of a laser exposure apparatus. In other words, a diameter of an exposure beam spot on the resist surface is represented by a following formula (4).

λ/NA (4)

Here, “λ” indicates a wavelength, while “NA” indicates a numerical aperture. For example, in a Kr⁺ laser (λ=351 nm), which is in widespread use as an exposure apparatus light source for mastering, if light is gathered through an objective lens of N.A. =0.9, a beam spot diameter is estimated to be 390 nm according to the above-described formula (4). A 2T signal pit length of a DVD-ROM is 0.4 μm, which is almost equal to the beam spot diameter. In a further high density HD DVD-ROM with a single layer capacity of 15 GB, a recording linear density is 0.153 μm/bit, while a 2T pit length is 0.204 μm, which is almost half of the spot diameter. Also for an exposure wavelength (230 to 270 nm) in an exposure apparatus with a Deep UV light source which is recently becoming widespread, a beam spot diameter in a case of an objective lens numerical aperture of 0.9 is 255 to 300 nm, which is larger than the 2T signal pit length. Therefore, in order to create an optical disc with a smaller liner density than the HD DVD-ROM as in the embodiment, it is required to create a minute pit that is smaller than a condensed spot diameter, if the above-described laser exposure apparatus is used.

In an optical disc with a higher density than that of the HD DVD-ROM, as a result of combined use of the signal processing employing the PRML method in which interference between adjacent signals is considered, a signal can be demodulated even when a reproduced signal amplitude is not large enough to clearly classify signals from respective pits. Thus, the recording linear density can be made large, so that large capacity recording information is realized. In the PRML method, since a reproduced signal waveform is demodulated to a closest reproduction waveform, level slice is not directly required. It is more important that the reproduced signal waveform is close to that of the reproduced signal from a presumed pit column than to maximize the amplitude of the reproduced signal from the pit. In other words, in a high density reproduction-only disc medium employing PRML, a pit form is not limited to a soccer-stadium shape and can be of a pit form enabling a reproduced signal suitable for a PRML processing. Accordingly, in the embodiment, the pit form is the one having the almost V-formed cross-section.

For reference, pit forms on conventional reproduction-only disc boards such as a CD and a DVD approximate the soccer-stadium shape as shown in FIG. 2(a) and FIG. 2(b), and the pit form in a rage of the conventional document (Patent Document 1: Japanese Patent Application Publication (KOKAI) No. 2004-206874) is applicable. In such reproduction only discs, since a mark edge method is employed to code the recoded signal, level slice of a reflected signal is necessary. Therefore, it is desirable that a signal level difference between a pit part and a space part is clear, and the pit form of the soccer-stadium shape, which has a large reproduced signal amplitude, is desirable even if asymmetry of the pit is somewhat large.

Further, in view of commercialization of products, it is desirable that the method is suitable for production in terms of a production yield, reliability and a lower cost. As a method of the exposure apparatus, an exposure method using a laser has conventionally been widely employed by the producer. Meanwhile, as a method for forming a minute pit, electron beam exposure can be also cited. The exposure by an electron beam has an ability to create a substantially minute pit, but is not suitable for production since the electron beam exposure is an exposure method in a vacuum chamber. Therefore, at present, it is difficult to employ the electron beam exposure as production equipment for the reproduction-only disc, of which a throughput is required. In contrast, the exposure using the laser beam is time-proven by having been employed in production, though the exposure using the laser beam has a limit in a beam spot system as described above. Accordingly, in order to manufacture the master of the optical disc of the embodiment, it is preferable to adopt a method with high manufacturing performance using the laser exposure apparatus, and by employing such a manufacturing method, it is possible to form a pit form array suitable for the high density signal processing by PRML. However, the master of the optical disc may be manufactured by the electron beam exposure.

(Simulation of Recording Pit Form)

The pit form which can be created by using the laser exposure apparatus can be explained by means of simulation in which an exposure intensity profile and a development etching profile are considered. In the disc master exposure apparatus, a modulation signal with a pulse width corresponding to a pit length is inputted to a light intensity modulation element such as an AOM (Acousto Optic Modulator) and an EOM (Electro Optic Modulator), whereby an intensity-modulated exposure beam is obtained. Therefore, the exposure intensity profile on a resist surface at a time of latent image recording of the pit can be simulated by overlapping the exposure intensity profile of the condensed spot on the electronic pulse modulation signal. The intensity profile of the condensed spot is calculated in presumption of a Fraunfofer diffraction image, with a numerical aperture of the objective lens being 0.9. Note that a peak value of an input pulse modulation signal is presumed to be the same.

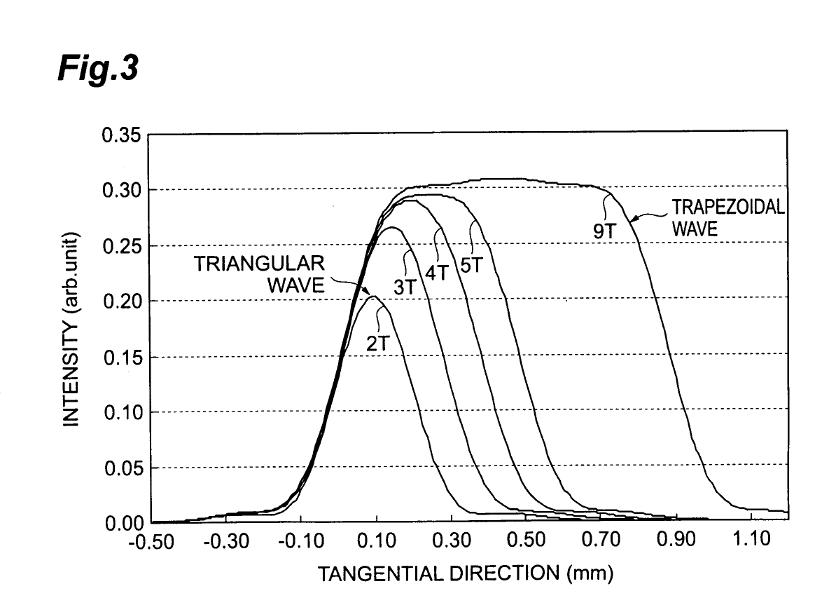

FIG. 3 shows a simulation result of the exposure intensity profile in a case that a recording pit is formed under a condition of an exposure wavelength of 351 nm, 8/12 modulation, and a linear density of 0.153 μm/bit, and in particular shows change in an optical disc circumferential direction (tangential direction) of the exposure intensity profile (intensity). In recording pits (pit lengths of 0.204 μm, 0.3 μm and 0.4 μm) of 2T, 3T and 4T signals, cross-sectional profiles of the exposure intensities are close to triangular waves, but at a time of pit recording of 5T pit or above, cross-sectional profiles of the exposure intensities are trapezoidal wave profiles. Therefore, in a case of recoding a pit length shorter than the exposure wavelength, the exposure intensity profile on the resist surface is the one close to a conical shape.

Based on the above-described exposure intensity profile of pit recording, an etching profile simulator at a time of development is created, and pit forms which can be created by using the laser exposure apparatus is verified and analyzed. Melt-etching process flow by development is calculated by using a model improved on Cell removal model (document: IEEE Trans. Computer-Aided Design, Vol. 10, No. 6, 802(1991)), and a following formula (5) representing a development speed R is employed.

R=Rₙ·{Iₙ(x,y,z)}^{γ}+Rₘᵢₙ (5)

Here, “Rₙ” indicates any development speed constant, “Iₙ” indicates a film-thickness reduction speed, and “Rₘᵢₙ” indicates a film-thickness reduction speed.

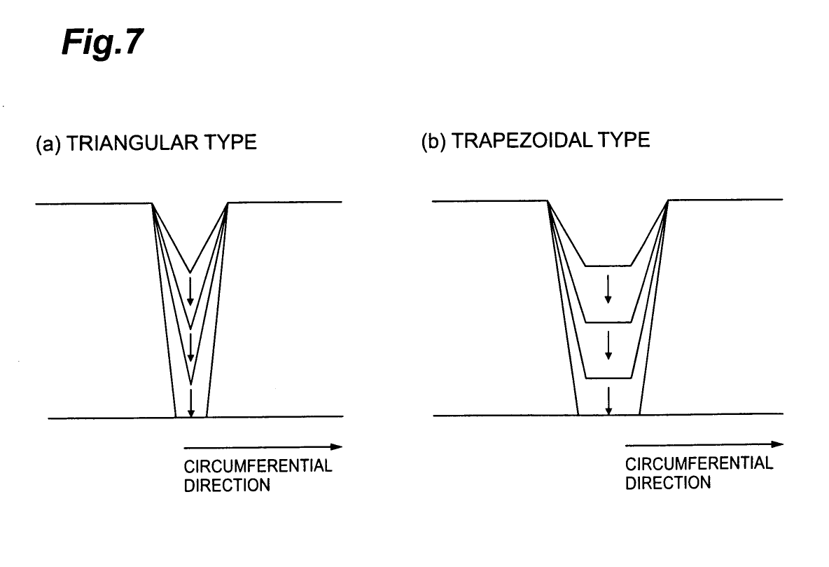

There are performed form simulations of three types of pits (2T, 3T, 4T) in which recording light amounts are changed, with a development time being presumed to be 30 seconds, and cross-sectional profiles in disc diameter directions obtained from the simulation are shown in FIG. 4, FIG, 5 and FIG. 6. Schematic views of the cross-sectional profiles in the disc circumferential directions are shown in FIG. 7(a) and FIG. 7(b). In FIG. 4 to FIG. 7(b), there are shown a plurality of cross-sectional profiles corresponding to lapses of the developing time. Before the development proceeds to a base, the pit form is almost V-shaped. When the development proceeds to the base, the pit form becomes trapezoidal. When the recording pits of the 2T (0.2 μm in pit length), 3T (0.3 μm in pit length), and 4T (0.4 μm in pit length) signals formed in the optical disc of the embodiment are actually manufactured, the development time is adjusted so that the development does not proceed to the base and that the development ends in a state that the recording pit is almost V-shaped.

Note that in the above-described simulation, an initial resist film thickness is 80 nm. Sufficient signal modulation factor is necessary for improvement of S/N of the reproduced signal. A reproduced signal modulation factor depends on a depth of a pit. In the reproduction-only optical disc, when presuming a rectangular pit, a base with a depth of a following formula (6) brings the largest reproduced signal modulation factor. Note that in the following formula (6), “λ” indicates a wavelength of laser while “n” indicates a refractive index of the resist material.

$$\frac{λ}{4 n} \qquad ( 6 )$$

Therefore, in a high capacity optical disc using a blue laser, a pit depth of about 63 nm is desirable, if a wavelength λ of a reading laser is 405 nm and a refractive index of polycarbonate is 1.6. However, in reality, the pit cross-section is triangular or trapezoidal as described above and the pit length is a full width at half maximum thereof. Since it is necessary to increase the depth to some extent in order for the pit length to be the same as the pit length of the rectangular shaped pit, a pit depth of an actual reproduction-only disc is adjusted to be 70 to 80 nm. In the above-described simulation, a resist film thickness of 70 to 80 nm is adopted.

According to the above-described simulation result, it is understood that there are two methods for obtaining a manufacturing margin of the pit formation. One is a method of stopping the development before the pit depth reaches the base bottom. The other is a method of making the pit depth reach the base bottom. In the conventional DVD and the like, depths of all pits reach a base and pit lengths are adjusted by a recording light amount, so that a pit form has a soccer-stadium shape. In order to create a good quality reproduction-only disc, a uniform pit form distribution is required on an entire disc surface. It is variation of the recording light amount that most influences the pit form during master recording. The variation of the recording amount is caused by swaying of a light source or variation of a focus due to bobbling, but a several percentage of light amount variation must be allowed.

(Test Production of Optical Disc)

If the development is in a state of just reaching the base, the form of the cross-section of the 2T signal pit, for example, rapidly changes, being triangular with a reduced light amount and being trapezoidal with an increased light amount. Since the full width at half maximum of the pit changes drastically on this occasion, the variation of the light amount causes substantial variation of the pit forms. Accordingly, it is necessary to record in a light amount which allows the triangular pit form cross-section to keep the triangular form or allows the trapezoidal pit form cross-section to keep the trapezoidal form to some extent, even if the light amount varies. Besides, a resist having a resolution with which the full width at half maximum corresponds to the pit length is desirable. Further, a state is desirable, as much as possible, that reproduced signal amplitudes from respective pits are balanced, that is, a state that asymmetry is equalized. It depends on the balance of the asymmetry of respective pits whether the respective pit depths reach the bottom or the respective pit depths do not reach the bottom. In PRML being a method for processing the reproduced signal read from the optical disc of the embodiment, an ideal signal wavelength (in a state of zero asymmetry) is presumed. Therefore, recorded information can be stably demodulated, if an entire reproduced signal waveform, rather than individual amplitude of the reproduced signal, is close to what is presumed.

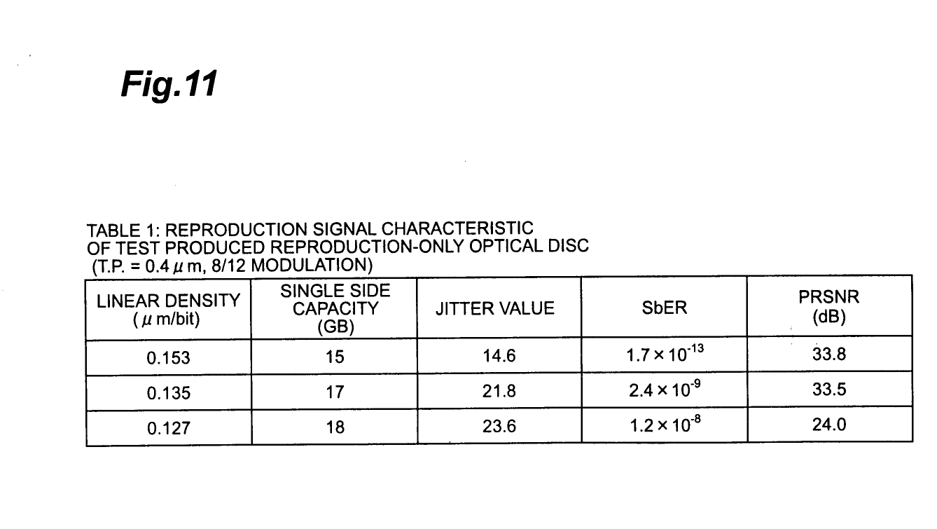

Here, an 8/12 modulated random bit signal is master-recorded with a track pitch being 0.4 μm, and under three conditions of linear densities of 0.153 μm/bit, 0.135 μm/bit and 0.127 μm/bit, and reproduction-only discs are test produced from these optical disc masters. Respective recording densities thereof are 15, 17, and 18 GB/surface. The reproduction-only optical disc is created by bonding formed boards of 0.6 t in thickness, similarly to in a DVD and a HD DVD. For reproduction evaluation of the signal, ODU1000 (λ=405 nm, N.A. 0.65) of Pulstec Industrial Co. Ltd. is employed to measure a jitter value, and PRSNR (Partial Response Signal to Noise Ratio) and SbER (Simulated bit Error Rate) being reproduced signal indexes in the PRML signal processing. For reproduction of recorded information, it is absolutely essential as a standard that PRSN is 15 dB or more and SbER is 1.0×10⁻⁵ or less. An evaluation result of the test-reproduced medium is shown in Table 1 of FIG. 11. Though the jitter value decreases in accordance with an increase of the linear density, SbER and PRSNR sufficiently satisfy the above-described requirements. In particular, in a case of the linear density of 0.135 μm/bit (17 GM/surface), though the jitter value is worse than in a case of the linear density of 0.153 μm/bit (15 GB/surface), PRSNR is almost the same.

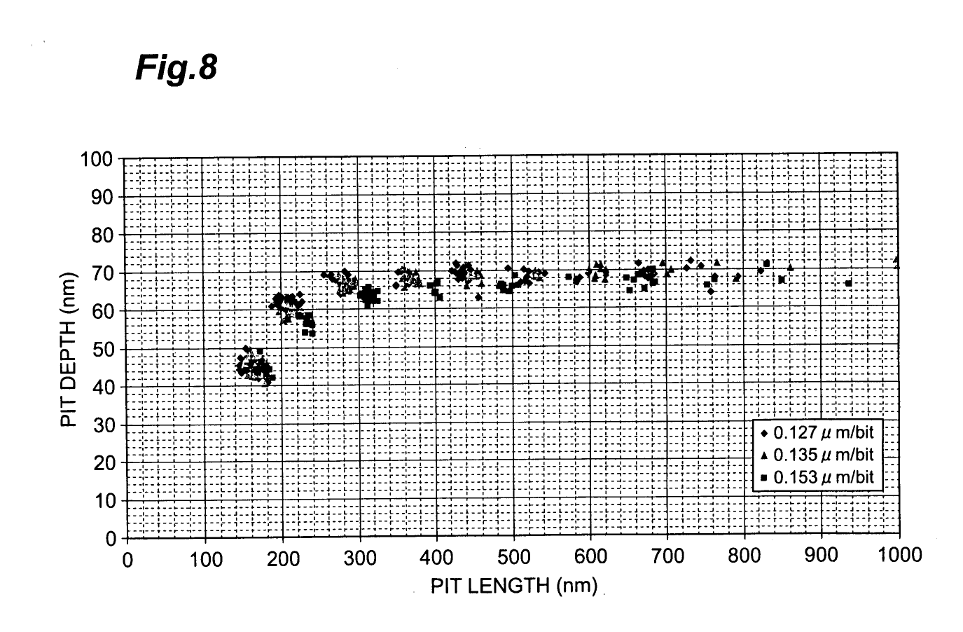

The pit forms in the created board in this case is observed with an atomic force microscope (AFM) to investigate a distribution of the pit forms, a graph of a result being shown in FIG. 8. It is known from the distribution of the pit lengths and depths in FIG. 8 that the depths of the 2T and 3T signal recording pits are shallow in any medium. Accordingly, it is revealed that if the recording linear density is smaller than 0.153 mm/bit the pit depths of not only the 2T signal recording pit but also of the 3T signal recording pit are shallower than that of a longer pit. In relation to the depth of the trapezoidal recording pit, the depths of 2T signal recording pits, in particular, are distributed in a range from 57% to 71%, while the depths of the 3T signal recording pits are distributed in a range from 74% to 91%.

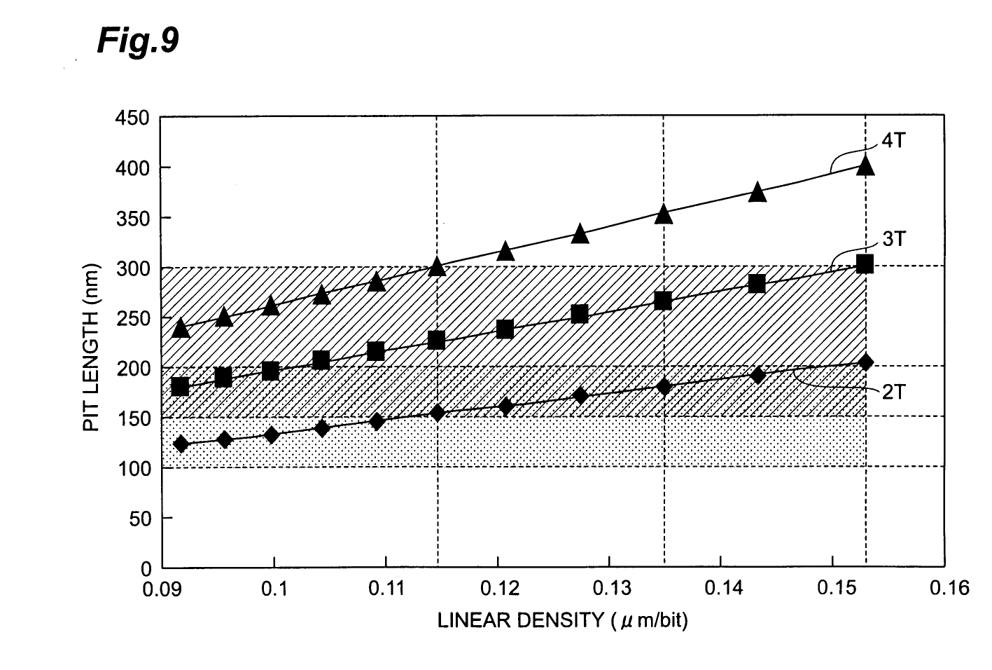

FIG. 9 is a graph plotting pit lengths of 2T, 3T and 4T signals in 8/12 modulation such as is used in an HD DVD standard in a case that the linear density is increased. In FIG. 9, a pit length L_{2T} (nm) of a 2T signal recording pit can be represented by a following formula (7).

L_{2T}=1333.3ρ(±10%) (7)

A pit length L_{3T} (nm) of a 3T signal recording pit can be represented by a following formula (8).

L_{3T}=1960.8ρ(±10%) (8)

A pit length L_{4T} (nm) of a 4T signal recording pit can be represented by a following formula (9).

L_{4T}=2614.4ρ(±10%) (9)

In the formulas (7) to (9), “ρ” indicates the linear density (μm/bit).

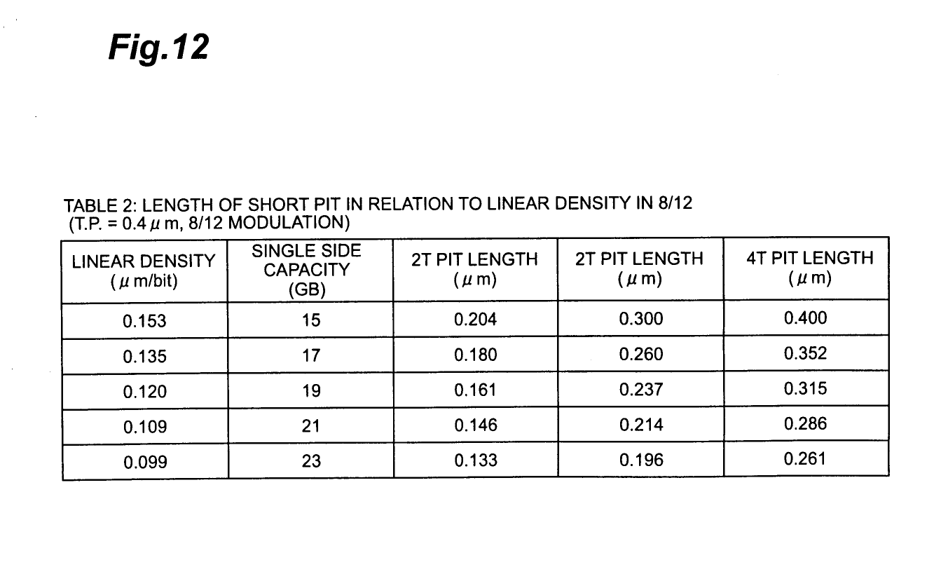

In Table 2 of FIG. 12 are shown lengths of short pits in each linear density in 8/12 modulation calculated by using the formulas (7) to (9). For example, the linear density of 0.153 μm/bit corresponds to a single layer storage capacity of 15 GB standard of an HD DVD in which a track pitch of 0.4 μm is adopted. As shown in FIG. 8, in the 2T signal pit length with the linear density of 0.153 μm/bit, the depth is 57% to 71% in relation to the depth of the long pit. Making the pit depth shallow as above leads to a good signal processing result in PRML. Whether such an effect is obtained or not depends simply on a reproduction optical system and the pit length, and not on the modulation method. Therefore, the effect is also obtained in an optical disc of a Blue-ray standard in which 1-7 modulation is employed, similarly to in the HD DVD standard.

(a) 2T Signal Recording Pit

A preferred form of the 2T signal recording pit in the embodiment, which is specified from the above-described result, will be described. The 2T pit length actually manufacturable has a lower limit value. Here, it is expected that the lower limit value of the 2T signal pit length is not lower than 0.1 μm, even considering improvement of a manufacturing technology of the pit length. Accordingly, in the embodiment, the lower limit value of the 2T signal pit length is set to be 0.1 μm. It is adequate that the lower limit value of the 2T bit length is set to be 0.1 μm, considering the present HD DVD standard and Blue-ray standard.

Further, the fact that a PRML signal processing characteristic of the recording pit of the embodiment is good is confirmed in the case of the linear density of 0.153 μm/bit or less, as shown in Table 1 of FIG. 11. Therefore, if the 2T signal pit length is 0.204 μm or less, in correspondence with the linear density of 0.153 μm/bit or less, the PRML signal processing characteristic is good. Thus, since the lower limit value of the 2T pit length is 0.1 μm and an upper limit value thereof is 0.2 μm, a following formula (10) is obtained for the 2T signal pit length L_{2T}.

0.1 μm≦L_{2T}≦0.2 μm (10)

The above-described formula (10) is applicable to a case that the pit length of the 2T signal recording pit is in a hatched (dotted) range of FIG. 9. From another point of view, the signal processing characteristic by PRML can be enhanced when a depth D_{2T} of the 2T signal recording pit can be represented by a following formula (11), with a depth of a trapezoidal recording pit being D₀.

$$0.6 \leq \frac{{D}_{2 T}}{{D}_{0}} \leq 0.7 \qquad ( 11 )$$

(b) 3T Signal Recording Pit

A preferable form of the 3T signal recording pit of the embodiment will be described. The 3T pit length actually manufacturable has a lower limit value. Here, it is expected that the lower limit value of the 3T signal pit length is not lower than 0.15 μm, even considering improvement of the manufacturing technology of the pit length. Accordingly, in the embodiment, the lower limit value of the 3T signal pit length is set to be 0.15 μm.

Further, the fact that the PRML signal processing characteristic of the recording pit of the embodiment is good is confirmed in the case of the linear density of 0.153 μm/bit or less, as shown in Table 1 of FIG. 11. Therefore, if the 3T signal pit length is 0.300 μm or less, in correspondence with the linear density of 0.153 μm/bit or less, the PRML signal processing characteristic is good. Thus, since the lower limit value of the 3T signal pit length is 0.15 μm and an upper limit value thereof is 0.3 μm, a following formula (12) is obtained for the 3T signal pit length L_{3T}.

0.15 μm≦L_{3T}≦0.3 μm (12)

The above-described formula (12) is applicable to a case that the pit length of the 3T signal recording pit is in a hatched (oblique line) range of FIG. 9. From another point of view, the signal processing characteristic by PRML can be enhanced when a depth D_{3T} of the 3T signal recording pit can be represented by a following formula (13), with the depth of the trapezoidal recording pit being D₀.

$$0.75 \leq \frac{{D}_{3 T}}{{D}_{0}} \leq 0.9 \qquad ( 13 )$$

(c) 4T Signal Recording Pit

As for the 4T signal recording pit, which is the third shortest, if the linear density thereof is 0.114 μm/bit or less, the pit length is in a hatched (oblique line) range. Therefore, the 4T signal pit length L_{4T} satisfies the above formula (12), so that the signal processing characteristic by PRML can be enhanced.

Further, the 2T signal recording pit and the 3T signal recording pit simultaneously have the above-described forms, and thereby the PRML signal processing characteristics can be further enhanced. Furthermore, the 2T signal recording pit, the 3T signal recording pit and the 4T signal recording pit simultaneously have the above-described forms, and thereby the PRML signal processing characteristics can be further enhanced.

[Optical Disc Reproducing Apparatus]

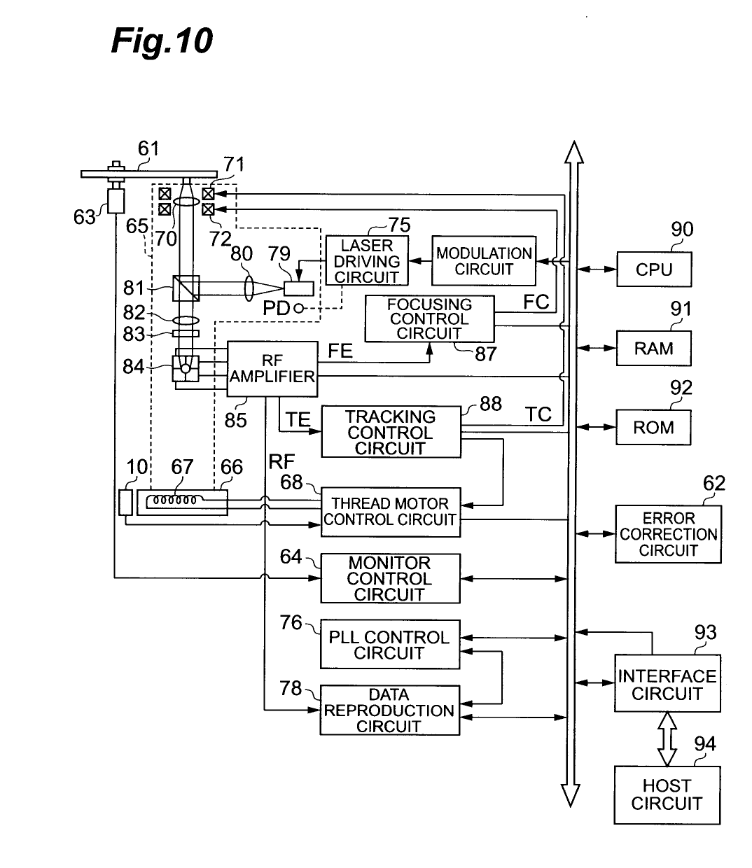

Next, there will be described an optical disc apparatus which records/reproduces information by using an optical disc on which a pit of the above-described form is formed. FIG. 10 is a block diagram showing a configuration of the optical disc apparatus according to the embodiment.

An optical disc 61 is a read-only optical disc or an optical disc capable of recording user data. The disc 61 is rotation-driven by a spindle motor 63. Recording/reproduction of information to/from the optical disc 61 is performed by an optical pick up head (hereinafter, referred to as PUH) 65. The PUH 65 is connected with a thread motor 66 via a gear, the thread motor 66 being controlled by a thread motor control circuit 68.

A seek address of the PUH 65 is inputted from a CPU 90 to the thread motor control circuit 68, and based on this address, the thread motor control circuit 68 controls the thread motor 66. A permanent magnet is fixed inside the thread motor 66, so that the PUH 65 moves in a radial direction of the optical disc 61 as a result of a driving coil 67 being excited by means of the thread motor control circuit 68.

The PUH 65 is provided with an objective lens 70 supported by a wire or a leaf spring which are not shown. The objective lens 70 is capable of moving in a focusing direction (optical axis direction of the lens) by driving of the driving coil 72 and is capable of moving in a tracking direction (direction perpendicular to the optical axis of the lens) by driving of the driving coil 71.

A laser beam is emitted from a semiconductor laser 79 by a laser driving circuit 75 in a laser control circuit. The laser beam emitted from the semiconductor laser 79 is irradiated onto the optical disc 61 through a collimator lens 80, a half prism 81 and the objective lens 70. A reflected light from the optical disc 61 is guided to a photo detector 84 through the objective lens 70, the half prism 81, a condenser lens 82 and a cylindrical lens 83.

The photo detector 84 is made up of four-split photo-detection cells, for example, and a detection signal of each split photo-detection cell is outputted to an RF amplifier 85. The RF amplifier 85 synthesizes signals from the photo-detection cells to generate an RF signal being a fully-added signal of a focus error signal FE indicating an error from a just focus, a tracking error signal TE showing an error between a beam spot center of the laser beam and a track center, and a photo-detector cell signal.

The focus error signal FE is supplied to a focusing control circuit 87. The focusing control circuit 87 generates a focus control signal FC in correspondence with the focus error signal FE. The focus control signal FC is supplied to the driving coil 72 in the focusing direction, and focus servo is performed so that the laser beam is always just focused on a recording film of the optical disc 61.

The tracking error signal TE is supplied to a tracking control circuit 88. The tracking control circuit 88 generates a tracking control signal TC in correspondence with the tracking error signal TE. The tracking error signal TC is supplied to the driving coil 72 in the tracking direction, and tracking servo is performed so that the laser beam always traces on the track formed on the optical disc 61.

As a result of the above-described focus servo and tracking servo, the full-added signal RF of the output signals of the respective light-detection cells of the photo detector 84 reflects a change in the reflected light from the pit formed on the track of the optical disc 61 and so on. The full-added signal RF is supplied to a data reproduction circuit 78. The data reproduction circuit 78 reproduces record data based on a reproducing clock signal from a PLL circuit 76.

When the objective lens 70 is controlled by the above-described tracking control circuit 88, the thread motor 66, that is, the PUH 65 is controlled by the thread motor control circuit 68 so that the objective lens 70 is positioned in a neighborhood of a predetermined point in the PUH 65.

A motor control circuit 64, the thread motor control circuit 68, the laser control circuit 73, the PLL circuit 76, the data reproduction circuit 78, the focusing control circuit 87, the tracking control circuit 88, an error correction circuit 62 and the like are controlled by the CPU 90 via a bus 89. The CPU 90 comprehensively controls the recording/reproducing apparatus according to an operation command provided by a host apparatus 94 via an interface circuit 93. The CPU 90 uses RAM 91 as a work area and performs a predetermined operation according to a program recorded in a ROM 92.

The data reproduction circuit 78 processes the imported RF signal by the PRML method to reproduce information and outputs reproduced video signal or sound signal to the outside.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An optical disc comprising a plurality of recording pits on a recording surface,
each of said plurality of recording pits comprising a circumferential direction length corresponding to record data, and
radial direction cross-sections of said recording pits of signals of 2T, 3T and 4T in said circumferential direction lengths comprising groove forms which have deepest points in the radial direction cross-sections and become shallower from the deepest points in correspondence with difference amounts in radial directions.

2. The optical disc according to claim 1,
wherein said circumferential direction length L_{2T} of said recording pit of the 2T signal satisfies
0.1 μm<L_{2T}<0.2 μm
, and wherein said circumferential direction length L_{3T} of said recording pit of the 3T signal satisfies
0.15 μm<L_{3T}<0.3 μm

3. The optical disc according to claim 1,
wherein the record data is reproduced in accordance with a PRML (Partial Response and Maximum Likelihood) method.

4. An optical disc comprising a plurality of recording pits on a recording surface,
each of said plurality of recording pits comprising a circumferential direction length corresponding to record data, and
a radial direction cross-section of said recording pit whose circumferential length Lₚ is represented by any one of formulas
Lₚ=1333.3ρ(±10%)
and
Lₚ=1960.8ρ(±10%)
and
Lₚ=2614.4ρ(±10%)
(ρ indicates a linear density) comprising a groove form which has a deepest point in the radial direction cross-section and becomes shallower from the deepest point in correspondence with a difference amount in a radial direction.

5. An optical disc reproducing apparatus, reading data from an optical disc comprising a plurality of recording pits on a recording surface,
each of said plurality of recording pits comprising a circumferential direction length corresponding to record data, and
radial direction cross-sections of said recording pits of signals of 2T, 3T and 4T in said circumferential direction lengths comprising groove forms which have deepest points in the radial direction cross-sections and become shallower from the deepest points in correspondence with difference amounts in radial directions.

6. An optical disc reproducing apparatus, reading data from an optical disc comprising a plurality of recording pits on a recording surface,
each of said plurality of recording pits comprising a circumferential direction length corresponding to record data, and
a radial direction cross-section of said recording pit whose circumferential length Lₚ is represented by any one of formulas
Lₚ=1333.3ρ(±10%)
and
Lₚ=1960.8ρ(±10%)
and
Lₚ=2614.4ρ(±10%)
(ρ indicates a linear density) comprising a groove form which has a deepest point in the radial direction cross-section and becomes shallower from the deepest point in correspondence with a difference amount in a radial direction.

7. An optical disc reproducing method, comprising:
reading data from an optical disc having a plurality of recording pits on a recording surface, each of the plurality of recording pits having a circumferential direction length corresponding to record data, and radial direction cross-sections of the recording pits of signals of 2T, 3T and 4T in the circumferential direction lengths having groove forms which have deepest points in the radial direction cross-sections and become shallower from the deepest points in correspondence with difference amounts in radial directions; and
reproducing the read data.

8. An optical disc reproducing method, comprising:
reading data from an optical disc having a plurality of recording pits on a recording surface, each of the plurality of recording pits having a circumferential direction length corresponding to record data, and a radial direction cross-section of the recording pit whose circumferential length Lₚ is represented by any one of formulas
Lₚ=1333.3ρ(±10%)
and
Lₚ=1960.8ρ(±10%)
and
Lₚ=2614.4ρ(±10%)
(ρ indicates a linear density) having a groove form which has a deepest point in the radial direction cross-section and becomes shallower from the deepest point in correspondence with a difference amount in a radial direction; and
reproducing the read data.
